(19) United States
(12) Patent Application Publication
(10) Pub. No.: US 2008/0158391 A1
(43) Pub. Date: Jul. 3, 2008

(54) DIGITAL CAMERA

(76) Inventor: Takeshi SUZUKI, Tokyo (JP)

Correspondence Address: John C. Pokotylo;STRAUB & POKOTYLO, Bldg. B, 2nd Floor, 620 Tinton Avenue, Tinton Falls, NJ, 07724-3260, US

(21) Appl. No.: 11/965,477

(22) Filed: Dec. 27, 2007

(30) Foreign Application Priority Data
Dec. 28, 2006 (JP) 2006-356337

(51) Int. Cl. H04N 5/76

(52) U.S. Cl. 348/231.99

(57) ABSTRACT

A digital camera includes: a shooting unit for shooting a subject and generating an image signal; a recording unit for recording on a recording medium image data based on the image signal obtained by the shooting unit; a shooting mode selection unit for selecting and setting a shooting mode for setting a shooting condition under which the subject is shot by the shooting unit; a positioning unit for locating the position thereof by receiving a plurality of signals transmitted from a plurality of signal sources; a power supply for supplying electric power to at least the shooting unit, the recording unit, and the positioning unit; and a control unit for controlling the operation of the positioning unit in accordance with the shooting mode selected and set by the shooting mode selection unit, and for controlling the electric power supplied from the power supply to the positioning unit.

This application claims the benefit of Japanese Application No. 2006-356337 filed in Japan on Dec. 28, 2006, the contents of which are incorporated herein by this reference.

### BACKGROUND OF THE INVENTION

1. Field of the Invention

The present invention relates to a digital camera, more specifically to a digital camera having a positioning function of locating the position thereof by receiving a plurality of signals transmitted from a plurality of signal sources.

2. Description of the Related Art

Conventionally, a so-called photographic device such as a digital camera has been widely used which is configured to perform a photoelectric conversion process on an optical image formed by a photographic optical system by using a photoelectric conversion device such as an image pickup device to obtain an optical image of a desired subject as an electrical image signal and record the image signal as digital data.

Further, as the conventional photographic device such as the digital camera, a variety of photographic devices have been proposed which are configured to include positioning means for positioning positional information so as to record image data obtained by a shooting operation and the positional information obtained at the time of the shooting by the positioning means, with the image data associated with the positional information.

In the above case, as the positioning means for positioning the positional information, a positioning technique called a Global Positioning System (hereinafter referred to as the GPS) is commonly used, for example. The GPS is a satellite positioning system capable of locating the present position (the latitude, the longitude, the altitude, and so forth) on the earth by receiving wireless signals transmitted from a plurality of orbiting satellites.

The wireless signals used in the GPS are faint signals of an extremely high frequency, and are transmitted from the satellites located in outer space 20,000 kilometers above the earth. Thus, the signals are susceptible to an obstacle, tending to be reflected or attenuated, for example. In the reception of the signals, therefore, accurate positioning or the positioning itself may fail according to circumstances in an environment in which the sky is not clearly visible.

Specifically, the signals from a plurality of (normally four) satellites necessary for locating a position may not be reliably acquired in, for example, a building (an indoor environment), woods filled with trees, a tunnel, a valley between buildings in a city, and so forth. However, there are cases in which the positioning can be performed even in the above-described environments. Therefore, whether or not the positioning can be performed at a given location cannot be determined until the positioning operation is actually performed at the location.

Meanwhile, the electric power consumed to perform the positioning operation is large in amount. In a small-sized device such as the digital camera mainly used for portable purposes, for example, the capacity of a power supply for driving device is limited. Thus, there is a demand for preventing unnecessary waste of electric power.

That is, if the positioning operation is performed when the device including the positioning means is in an environment in which a positioning result from the positioning operation cannot be reliably obtained, and if the positioning eventually fails, the positioning operation may be wasted to unnecessarily consume the electric power.

Meanwhile, to perform the shooting operation by using a photographic device such as a normal digital camera, it is necessary to previously perform, prior to the shooting operation, a variety of settings such as the exposure setting, the white balance setting, the presence or absence of fill light emitted from a strobe device or the like, and the amount of the fill light to be emitted, for example, in accordance with the state of the subject to be shot, the surroundings of the subject, and so forth (which is referred to as the shooting scene).

In view of the above, it is conceivable to predict whether or not the shooting scene in a given circumstance is suitable for the positioning operation by the GPS, with attention focused on an arbitrary setting value among the setting values set in accordance with the shooting scene, the use state of the device, and so forth.

For example, a digital camera disclosed in Japanese Unexamined Patent Application Publication No. 10-210336 is configured such that, when the digital camera is in an operable state supplied with electric power from a commercial power supply, or when a color temperature generated in an indoor environment is detected by a colorimetric sensor, the positioning function (the GPS) is turned off to stop the positioning operation.

According to the above configuration, it is possible to determine whether the positioning cannot be performed and to perform an ON-OFF control of the state of the positioning function in accordance with the use state of the digital camera or the condition of the color temperature of the subject at the time of the shooting.

### SUMMARY OF THE INVENTION

A digital camera according to an aspect of the present invention includes a shooting unit, a recording unit, a shooting mode selection unit, a positioning unit, a power supply, and a control unit. The shooting unit shoots a subject and generates an image signal. The recording unit records on a recording medium image data based on the image signal obtained by the shooting unit. The shooting mode selection unit selects and sets a shooting mode for setting a shooting condition under which the subject is shot by the shooting unit. The positioning unit locates the position thereof by receiving a plurality of signals transmitted from a plurality of signal sources. The power supply supplies electric power to at least the shooting unit, the recording unit, and the positioning unit. The control unit controls the operation of the positioning unit in accordance with the shooting mode selected and set by the shooting mode selection unit, and controls the electric power supplied from the power supply to the positioning unit.

Advantages of the above aspect of the present invention will be further clearly understood from the following detailed description.

### BRIEF DESCRIPTION OF THE DRAWINGS

FIG. 1 is a configuration block diagram illustrating a main configuration of a digital camera according to a first embodiment of the present invention;

FIG. 2 is a configuration block diagram of essential parts, illustrating a main configuration of positioning means extracted from the digital camera of FIG. 1;

FIG. 3 is a flowchart illustrating an operation performed in a shooting operation by the digital camera of FIG. 1, and illustrating a processing sequence of the flow of the shooting operation involving a GPS positioning operation performed in the digital camera;

FIG. 4 is a flowchart of a processing sequence constituting the processing sequence of FIG. 3, illustrating details of the GPS positioning operation;

FIG. 5 is a diagram illustrating a display example of a positioning error display displayed in the processing sequence of the GPS positioning operation of FIG. 4;

FIG. 6 is a flowchart illustrating an operation performed in a shooting operation by a digital camera according to a second embodiment of the present invention, and illustrating a processing sequence of the flow of the shooting operation involving a GPS positioning operation performed in the digital camera; and

FIG. 7 is a flowchart of a processing sequence constituting the processing sequence of FIG. 6, illustrating details of an operation performed when a positioning operation process is performed in a power-saving mode.

### DETAILED DESCRIPTION OF THE PREFERRED EMBODIMENTS

A digital camera according to an embodiment of the present invention is configured to include shooting means (a shooting unit), recording means (a recording unit), and positioning means (a positioning unit). The shooting means receives the light of the image of a subject formed by an optical lens or the like, for example, and photoelectrically converts the image through an image pickup device or the like to obtain an electrical image signal. The recording means records on a recording medium or the like the image signal obtained by the shooting means as an image file containing digital image data and shooting data related to the digital image data. The positioning means uses a GPS to locate the position thereof on the earth by receiving wireless signals from a plurality of positioning satellites serving as signal sources.

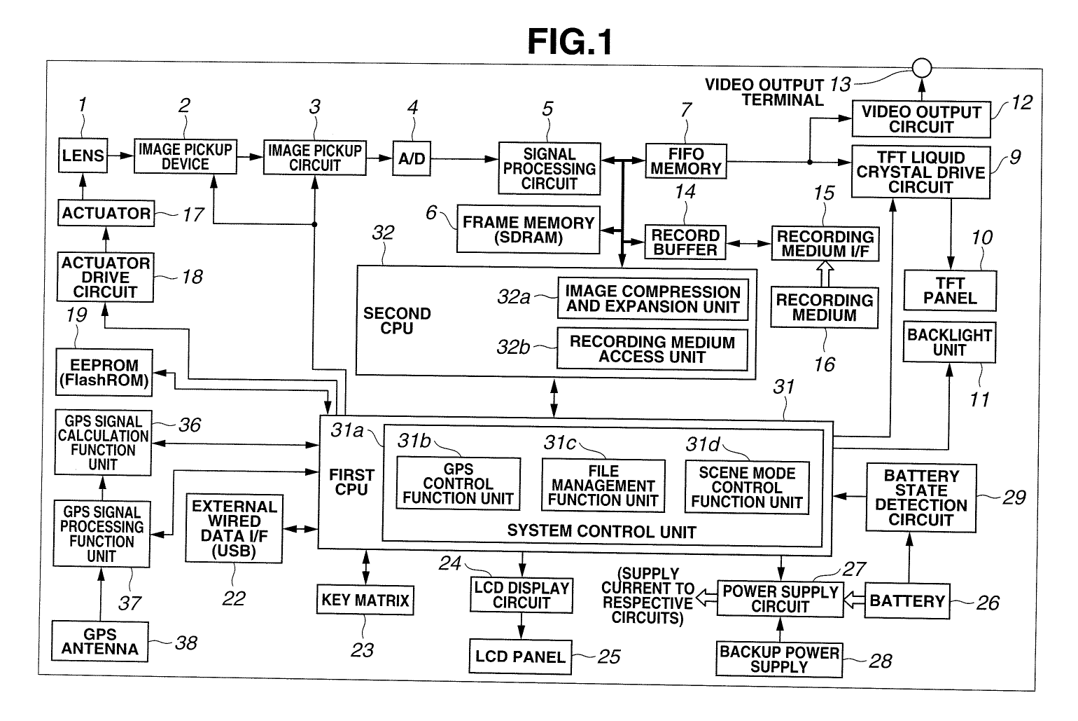

That is, as illustrated in FIG. 1, the digital camera according to the present embodiment is mainly constituted by a lens 1, an image pickup device 2, an image pickup circuit 3, an A/D (Analog-to-Digital) converter (indicated simply as “A/D” in FIG. 1) 4, a signal processing circuit 5, a frame memory 6, a FIFO (First-In-First-Out) memory 7, a TFT (Thin Film Transistor) liquid crystal drive circuit 9, a TFT panel 10, a backlight unit 11, a video output circuit 12, a video output terminal 13, a record buffer 14, a recording medium interface (a recording medium I/F) 15, a recording medium 16, an actuator 17, an actuator drive circuit 18, an external wired data interface (an external wired data I/F) 22, a key matrix 23, an LCD (Liquid Crystal Display) display circuit 24, an LCD panel 25, a battery 26, a power supply circuit 27, a backup power supply 28, a battery state detection circuit 29, a first CPU (Central Processing Unit) 31, a second CPU 32, an EEPROM (Electronically Erasable and Programmable Read Only Memory) 19, a GPS signal calculation function unit 36, a GPS signal processing function unit 37, a GPS antenna 38, and so forth.

The lens 1 is provided to generate an optical image of the subject and form the optical image on a light-receiving surface of the image pickup device 2.

The image pickup device 2 is a device for receiving the optical image of the subject formed by the lens 1, performing a photoelectric conversion process on the optical image, and outputting an electrical image signal. An image pickup device applicable as the image pickup device 2 includes a solid-state image pickup device of a type capable of performing a high-speed readout, such as a CCD (Charge-Coupled Device), a CMOS (Complementary Metal-Oxide Semiconductor), and other various types of image pickup devices, for example.

The image pickup circuit 3 is an electronic circuit for receiving the image signal outputted from the image pickup device 2 and performing various types of analog signal processing on the image signal.

The A/D converter 4 is a circuit for receiving the analog-formatted image signal outputted from the image pickup circuit 3 and converting the image signal into a digital-formatted image signal.

The signal processing circuit 5 is a circuit for receiving the digital-formatted image signal outputted from the A/D converter 4 and performing various types of digital signal processing.

The frame memory 6 constitutes temporary storage means for receiving the image signal processed by the signal processing circuit 5 and temporarily storing the processed image signal, a variety of data relating to the image signal, and so forth. As the frame memory 6, a semiconductor storage device or the like such as an SDRAM (Synchronous Dynamic Random Access Memory) is applied, for example.

In the digital camera according to the present embodiment, the lens 1, the image pickup device 2, the image pickup circuit 3, the A/D converter 4, the signal processing circuit 5, and the frame memory 6 described above, for example, constitute a major part of the shooting means for shooting the subject and generating the image signal.

The FIFO memory 7 is a memory provided to temporarily store the image signal when the image signal is outputted to a variety of display devices.

The TFT liquid crystal drive circuit 9 is a circuit for receiving the image signal outputted from the FIFO memory 7 and controlling the TFT panel 10.

The TFT panel 10 is a display unit for displaying an image based on the image signal, a variety of information of the digital camera, and so forth in accordance with the control by the TFT liquid crystal drive circuit 9. As the TFT panel 10, a TFT panel capable of performing color display is used.

The backlight unit 11 is provided on the back side of the TFT panel 10 to illuminate the TFT panel 10 from the back side.

In the digital camera according to the present embodiment, the TFT liquid crystal drive circuit 9, the TFT panel 10, and the backlight 11 described above, for example, constitute a major part of display means for displaying the image of the subject shot by the shooting means as an electronic image.

The video output circuit 12 is a circuit for receiving the image signal from the FIFO memory 7, converting the image signal into a video signal of an NTSC (National Television Standards Committee) format, for example, and outputting the video signal via the video output terminal 13 to an external display device or the like connected to the video output terminal 13.

The video output terminal 13 is a connection terminal for connecting a signal line such as a video cable for electrically connecting the digital camera and the external display device or the like.

The record buffer 14 is a buffer (a temporary storage area) used, for example, when recording the image signal and so forth temporarily stored in the frame memory 6 onto the recording medium 16 as the image file containing the image data and the shooting data of the image data, or when reading the image file from the recording medium 16 and temporarily storing the image file in the frame memory 6.

The recording medium I/F 15 is for controlling such processes as the process of recording the image data and so forth on the recording medium 16 and the process of reading the image data and so forth from the recording medium 16.

The recording medium 16 is a nonvolatile recording medium for recording thereon the image data and other various types of data, such as a memory card of a thin plate shape or a card shape, for example. The recording medium 16 can be configured in a variety of ways. For example, the recording medium 16 may be configured to be attachable and detachable with respect to a device such as the digital camera, or to be fixed to an electrical circuit provided inside the device such as the digital camera. The recording medium 16 of any configuration is applicable to the digital camera according to the present embodiment.

The recording medium 16 included in the digital camera according to the present embodiment is configured to be attachable and detachable with respect to the camera.

The record buffer 14, the recording medium I/F 15, and the recording medium 16 described above, for example, constitute a main part of the recording means for recording on the recording medium 16 the image signal relating to the image shot by the shooting means, the shooting data of the image, and so forth as data of a predetermined format.

The actuator 17 is a drive source for driving the lens 1 to perform an auto focusing operation or a zooming operation.

The actuator drive circuit 18 is a circuit for controlling and driving the actuator 17 on the basis of the control by the first CPU 31.

The external wired data interface (the external wired data I/F) 22 is a connecting portion (an interface) for performing transmission and reception of data and so forth between the digital camera and an external device via a connection cable or the like. As the external wired data interface 22, an interface in conformity to the USB (Universal Serial Bus) standard or the IEEE (The Institute of Electrical and Electronics Engineers) 1394, for example, is applied.

The external wired data interface (the external wired data I/F) 22 and the connection cable (not illustrated) constitute a main part of communication means for transmitting and receiving information with the external device by using a fixed line.

The key matrix 23 is used as a collective term for operation input means including a variety of operation switches, operation buttons, and so forth provided to the digital camera according to the present embodiment. That is, a specific configuration example of the key matrix 23 is constituted by, for example, a variety of operation members and so forth, switching members each generating a predetermined instruction signal in conjunction with each of the plurality of operation members, and an electrical circuit for transmitting the instruction signal generated by each of the switching members. The variety of operation members include, for example, a power supply button for switching the state of the power supply of the digital camera between an ON state and an OFF state, a release button for starting the shooting operation, a four-way selection key (alternatively referred to as a cross key) used to perform a variety of settings such as the selection and setting of the type of a shooting mode, and a confirmation button (an OK button) used to issue a confirmation instruction for confirming the selected setting. A signal generated in accordance with the operation by a user of the variety of operation members of the key matrix 23 is outputted to the first CPU 31.

The LCD display circuit 24 is a circuit for controlling the LCD panel 25 on the basis of the control by the first CPU 31 to cause the LCD panel 25 to display a variety of information.

The LCD panel 25, which is constituted by a monochrome LCD and so forth, for example, is an information display member for displaying such information as the information of a variety of settings set in the digital camera, the information of the operation mode including the shooting mode and so forth, for example, the information of the number of images recordable on the recording medium 16, and the information relating to the exposure including the shutter speed and the aperture value in the shooting operation.

The battery 26 is a main power supply of the digital camera. The battery 26 supplies electric power to the respective electrical circuits of the digital camera, such as the shooting means including the image pickup device 2 and so forth, the recording means including the recording medium 16 and so forth, and the positioning means including the GPS antenna 38 and so forth, for example.

The backup power supply 28, which is provided to constantly supply electric power to an internal memory, an internal clock, and so forth of the digital camera, serves as a sub power supply for holding such information as the date information and the information of the variety of setting values set in the digital camera and for enabling constant display of the date with the use of the LCD display panel 25 or the like.

The power supply circuit 27 is a circuit for receiving power supply from the battery 26 and the backup power supply 28 and performing a control to appropriately supply the power to the respective electrical circuits provided in the digital camera on the basis of a command from the first CPU 31.

The battery state detection circuit 29 is a circuit for detecting the state of the battery 26 such as the voltage of the battery 26, calculating the remaining battery power of the battery 26 and so forth, and outputting the result of the calculation to the first CPU 31.

The first CPU 31, which is provided as a main CPU, constitutes control means for performing an overall control of the respective circuits of the digital camera according to the present embodiment. Therefore, the first CPU 31 of the digital camera includes a system control unit 31a for appropriately controlling the whole system of the digital camera.

The system control unit 31a is configured to include therein a variety of electrical circuits including control circuits for realizing a variety of functions, such as a GPS control function unit 31b, a file management function unit 31c, and a scene mode control function unit 31d (described in detail later), for example. The GPS control function unit 31b constitutes a part of the positioning means (described in detail later), and performs a function of controlling the positioning means. The file management function unit 31c constitutes a function unit for managing the image file recorded on the recording medium 16. The scene mode control function unit 31d constitutes a function unit for performing a control relating to a shooting scene mode included in the shooting mode.

As described above, the first CPU 31 constitutes the control unit for mainly controlling the respective constituent components. Meanwhile, the second CPU 32 constitutes a control unit for mainly controlling a variety of processes handling the image data and so forth. Therefore, the second CPU 32 is configured to include an image compression and expansion unit 32a, a recording medium access unit 32b, and so forth.

The image compression and expansion unit 32a is a circuit unit for reading the image data stored in the frame memory 6, generating a single image file by combining the image data and the shooting data accompanying the image data, and performing, for example, a JPEG (Joint Photographic Experts Group) compression process on the image file or performing an expansion process of the compressed image file read from the recording medium 16 via the later-described recording medium access unit 32b.

The recording medium access unit 32b is a circuit unit for controlling the access of the recording medium I/F 15 to the recording medium 16.

The EEPROM 19 is a nonvolatile recording medium for storing and holding processing programs (application software) executed by the first CPU 31 and the second CPU 32, data of a variety of setting parameters corresponding to the respective shooting scene modes, other various types of setting data and the unique data of the digital camera, and so forth. As the EEPROM 19, a flash ROM or the like is applied, for example.

The GPS antenna 38, which constitutes an input unit for receiving the wireless signals from the plurality of positioning satellites, is connected to the GPS signal processing function unit 37. Accordingly, the wireless signals from the positioning satellites received by the GPS antenna 38 are inputted to the GPS signal processing function unit 37.

The GPS signal processing function unit 37 has a function of receiving the wireless signals from the positioning satellites received by the GPS antenna 38, performing predetermined signal processing on the wireless signals, and converting the wireless signals into electrical signals of a predetermined format. The GPS signal processing function unit 37, which is connected to the GPS signal calculation function unit 36 and the first CPU 31, operates in accordance with the control by the GPS control function unit 31b of the first CPU 31, and outputs the signals subjected to the signal processing to both of the GPS signal calculation function unit 36 and the first CPU 31.

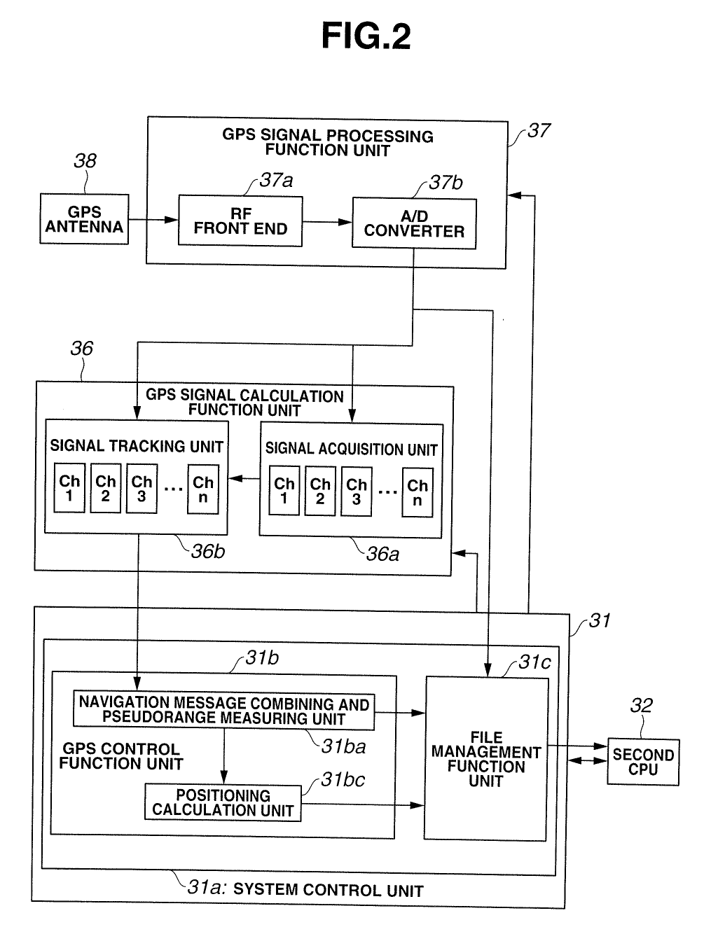

In a detailed configuration of the GPS signal processing function unit 37, the GPS signal processing function unit 37 is configured to include therein an RF (Radio Frequency) front end 37a, an A/D converter 37b, and so forth, as illustrated in FIG. 2.

The RF front end 37a is a circuit for converting (down-converting) the wireless signals (referred to as the GPS signals) from the positioning satellites received by the GPS antenna 38 into signals of an intermediate frequency by using a bandpass filter or the like.

The A/D converter 37b is a circuit for receiving the output (analog signals) from the RF front end 37a and converting the analog signals into digital signals.

The electrical signals subjected to the signal processing and outputted from the A/D converter 37b are outputted to the GPS signal calculation function unit 36, and is also outputted to the file management function unit 31c of the system control unit 31a of the first CPU 31.

The GPS signal calculation function unit 36 has a function of receiving the electrical signals subjected to the signal processing by the GPS signal processing function unit 37 and performing predetermined calculation processing on the electrical signals. The GPS signal calculation function unit 36, which is connected to the first CPU 31, operates in accordance with the control by the GPS control function unit 31b of the first CPU 31, and outputs the result of the calculation to the first CPU 31.

As illustrated in FIG. 2, the GPS signal calculation function unit 36 is configured to include therein a signal acquisition unit 36a, a signal tracking unit 36b, and so forth.

The signal acquisition unit 36a constitutes satellite acquisition means capable of simultaneously acquiring a plurality of positioning satellites. Therefore, the signal acquisition unit 36a includes a plurality of channels Chn (n represents an integral number) such as Ch1, Ch2, and so forth. Each of the respective channels performs a GPS signal acquisition operation process for acquiring the wireless signals (the GPS signals) from the positioning satellites. In accordance with the state of a given situation, the GPS control function unit 31b of the first CPU 31 performs a control to limit the operation by causing the GPS signal acquisition operation process to be performed simultaneously and in parallel through the plurality of channels of the signal acquisition unit 36a, or by causing the GPS signal acquisition operation process to be performed only through at least a particular one of the channels, for example.

The signal tracking unit 36b is a circuit for tracking the wireless signals from the positioning satellites acquired by the respective channels Chn such as Ch 1, Ch2, and so forth of the signal acquisition unit 36a, and performing a calculation process to continue to receive the wireless signals from the respective positioning satellites. A signal outputted from the signal tracking unit 36b is outputted to the GPS control function unit 31b of the first CPU 31.

The GPS control function unit 31b of the first CPU 31 receives the above signal, and performs a navigation message combining process, a pseudorange measuring process, and so forth in a navigation message combining and pseudorange measuring unit 31ba. The result of the processes is sent to a positioning calculation unit 31bc provided in the GPS control function unit 31b. Upon receipt of the result, the positioning calculation unit 31bc calculates a positioning result. The positioning result thus obtained by the positioning calculation unit 31bc is transmitted to the file management function unit 31c of the system control unit 31a as positioning data (numerical information of the latitude, the longitude, the altitude, and so forth) for locating the position on the earth of the digital camera.

As described above, the GPS antenna 38, the GPS signal processing function unit 37, the GPS signal calculation function unit 36, and the GPS control function unit 31b provided in the system control unit 31a of the first CPU 31, for example, constitute a main part of the positioning means for locating the position on the earth of the digital camera.

The file management function unit 31c of the system control unit 31a of the first CPU 31 performs a file management process, such as a process of associating the positioning data outputted from the above-described GPS control function unit 31b with the image data obtained by the shooting operation. Then, the positioning data is transmitted to the second CPU 32 via the file management function unit 31c.

The second CPU 32 performs a process of adding the positioning data from the file management function unit 31c to the corresponding shooting data and combining the shooting data with the corresponding image data to generate a single image file.

The thus generated image file is subjected to the compression process by the image compression and expansion unit 32a, as described above. The compressed image file is recorded on the recording medium 16 by the recording medium access unit 32b via the record buffer 14 and the recording medium I/F 15.

The whole or a part of the result of the process performed by the navigation message combining and pseudorange measuring unit 31ba is transmitted to the file management function unit 31c as intermediate processed data. Further, as described above, a part of the signals outputted from the A/D converter 37b is outputted to the file management function unit 31c as raw data of the GPS signals, i.e., the wireless signals received from the positioning satellites. The intermediate processed data and the raw data of the GPS signals are also managed by the file management function unit 31c.

As described above, the scene mode control function unit 31d of the system control unit 31a of the first CPU 31 constitutes the function unit for performing the control relating to the shooting scene mode included in the shooting mode.

Simply described, the scene mode control function unit 31d functions as shooting mode selection means (a shooting mode selection unit) for selecting and setting the shooting mode (including the shooting scene mode) for setting the shooting condition under which the subject is shot by the shooting means such as the image pickup device 2.

That is, the digital camera according to the present embodiment has the shooting scene mode (hereinafter referred to as the scene mode) as an operation pattern used in the shooting operation, i.e., one of the operation modes in the shooting mode.

The scene mode is an operation mode for enabling simultaneous and automatic setting of a variety of setting values expected to be optimized in accordance with the state of a shooting target in an assumed specific shooting scene, i.e., setting values of a plurality of setting items such as the exposure and the white balance expected to be previously adjusted to the shooting condition suitable for the shooting scene.

Specific examples of the scene mode include, for example, portrait, landscape, night scene, sports, sunset, fireworks, beach, snow, nature macro, panorama, indoor, candle, silent, underwater, and so forth.

Among the above scene modes, a desired scene mode is set in accordance with the selection and instruction made by the user through the operation of a predetermined operation member of the key matrix 23 prior to the shooting operation. In the above process, the scene mode control function unit 31d receives an instruction signal from the key matrix 23, and performs such a control as the setting of the variety of setting values corresponding to the selected and set scene mode.

The other components of the present digital camera unrelated to the present invention are assumed to be similar in configuration to the components of a normal and common digital camera. Thus, illustration and description of details of the other components will be omitted.

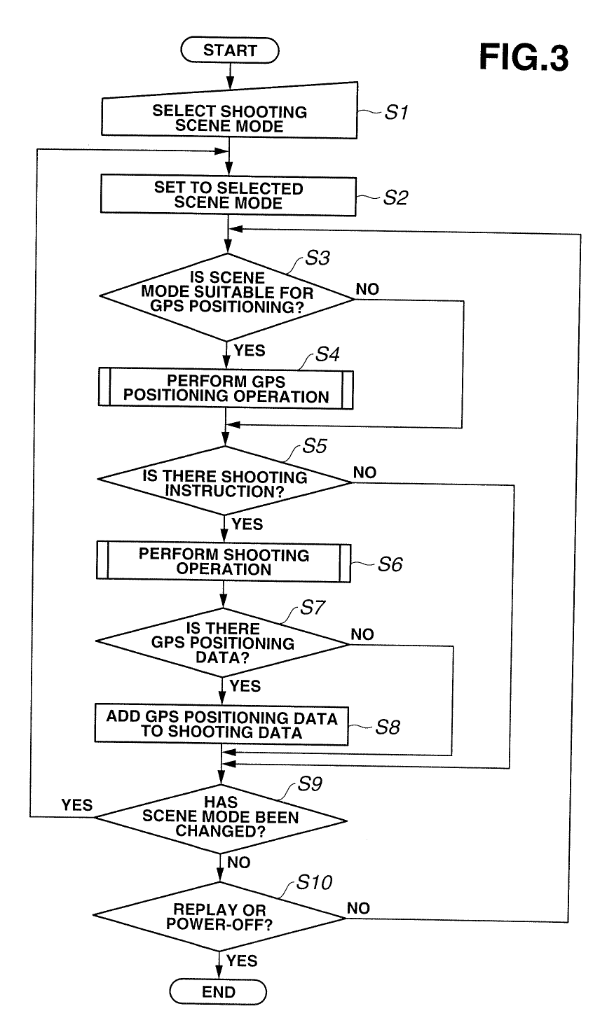

With reference to FIG. 3, description will be made below of an operation performed in the shooting operation by the digital camera of the above configuration according to the present embodiment.

It is now assumed that the power supply of the digital camera according to the present embodiment is in the ON state, and that the digital camera is in a state in which the shooting operation can be performed, i.e., the digital camera is set to the shooting mode.

In the above-described state, the user first performs a selection operation of selecting a desired operation mode from a plurality of operation patterns prepared for the shooting operation.

Herein, if the selection and instruction of the scene mode is made through the selection and instruction operation by the user, as described in Step S1 of FIG. 3, the operation proceeds to the next Step S2.

That is, the user herein operates a predetermined operation member of the key matrix 23 (e.g., the cross key, the confirmation button, and so forth) to select and set a desired scene mode from the display of a plurality of scene modes displayed on the display unit (not illustrated) or the like, for example. In the above process, the instruction signal generated by the key matrix 23 is transmitted to the scene mode control function unit 31d of the system control unit 31a of the first CPU 31.

Then, at the Step S2, the scene mode control function unit 31d sets the selected and instructed scene mode, and performs the process of setting and controlling the variety of setting values corresponding to the scene mode. Thereafter, the operation proceeds to Step S3.

At the Step S3, the scene mode control function unit 31d confirms whether or not the scene mode selected and instructed at the Step S1 and set at the Step S2 is suitable for the positioning operation by the GPS.

In the above case, scene modes suitable for the positioning operation by the GPS include, for example, portrait, landscape, night scene, sports, sunset, fireworks, beach, snow, nature macro, panorama, and so forth. The above scene modes are normally selected and instructed when the environment of the shooting operation is mainly in the open air. If the above scene modes are selected and set, it is assumable that the digital camera is in an obstacle-free condition such as the open air, i.e., an environment suitable for the positioning operation by the GPS.

Meanwhile, scene modes unsuitable for the positioning operation by the GPS include, for example, indoor, candle, silent, underwater, and so forth, i.e., scene modes in which a subject is assumed to be shot mainly in an indoor or underwater environment, for example. If such scene modes are selected and set, it is assumable that the digital camera is in an environment unsuitable for the positioning operation by the GPS, such as the indoor or underwater environment.

Then, if it is determined in the process of the Step S3 that the set scene mode is suitable for the positioning operation by the GPS, the operation proceeds to the next Step S4. Meanwhile, if it is determined in the process that the set scene mode is unsuitable for the positioning operation by the GPS, the operation proceeds to the process of Step S5.

At the Step S4, the GPS control function unit 31b performs the positioning operation process using the GPS. After the completion of the process of the Step S4, the operation proceeds to the process of the Step S5.

That is, if it is determined in the process of the Step S3 that the set scene mode is suitable for the positioning operation by the GPS, the positioning operation process is performed in the process of the next Step S4. Meanwhile, if it is determined in the process of the Step S3 that the set scene mode is unsuitable for the positioning operation by the GPS, the positioning operation process of the Step S4 is not performed, and the operation proceeds to the process of the next Step S5, i.e., the shooting operation.

In other words, if it is determined in the process of the Step S3 that the set scene mode is unsuitable for the positioning operation by the GPS, the first CPU 31 constituting the control means, i.e., the control unit performs a control to stop the GPS control function unit 31b to prevent the GPS control function unit 31b from performing the positioning operation process of the positioning means, and also controls the battery 26 and so forth via the power supply circuit 27 to stop or limit the power supply to the constituent components constituting the positioning means (the positioning unit), such as the GPS antenna 38, the GPS signal processing function unit 37, and the GPS signal calculation function unit 36.

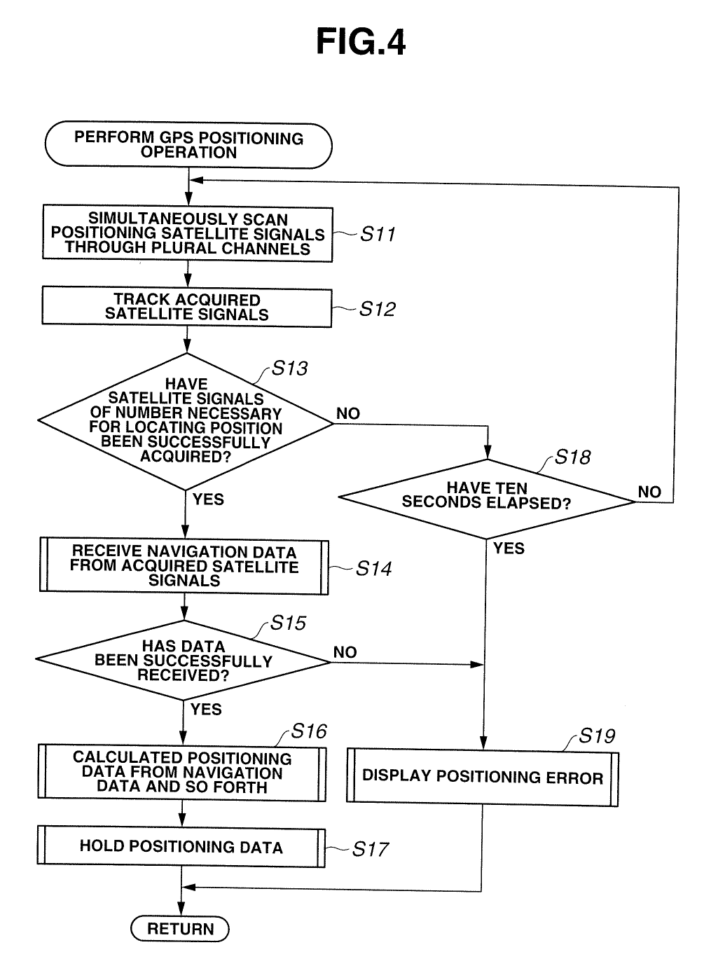

With reference to FIGS. 2 and 4, description will be made below of details of the process of the Step S4, i.e., the GPS positioning operation process.

The GPS positioning operation process illustrated in FIG. 4 is performed under the control of the GPS control function unit 31b of the system control unit 31a of the first CPU 31.

Firstly, at Step S11, the GPS control function unit 31b controls the GPS signal processing function unit 37 and the signal acquisition unit 36a of the GPS signal calculation function unit 36 to perform the GPS signal acquisition operation process simultaneously and in parallel in the plurality of channels to thereby scan the wireless signals from the positioning satellites. At the time of starting the GPS positioning operation process, the first CPU 31 starts a timekeeping operation by using an RTC (Real-Time Clock) internal clock thereof.

Then, at Step S12, the GPS control function unit 31b controls the signal tracking unit 36b of the GPS signal calculation function unit 36 to perform a process of tracking the wireless signals from the positioning satellites acquired by the respective channels of the signal acquisition unit 36a in the process of the Step S11, and continuing to receive the wireless signals from the respective positioning satellites.

At Step S13, the GPS control function unit 31b confirms whether or not satellite signals of a number necessary for the positioning (the locating of the position) have been successfully acquired in the processes of the Steps S11 and S12. Herein, if the GPS control function unit 31b determines that the necessary number of satellite signals have been successfully acquired, the GPS control function unit 31b proceeds to the process of the next Step S14. Meanwhile, if it is determined that the necessary number of satellite signals have failed to be acquired, the GPS control function unit 31b proceeds to the process of Step S18.

At the Step S18, the GPS control function unit 31b refers to the RTC internal clock (not illustrated) of the first CPU 31 to confirm whether or not a predetermined time (ten seconds in the present embodiment, for example) has elapsed since the starting time of the process of the Step S11. Herein, if the predetermined time (ten seconds) has not elapsed, the operation returns to the process of the Step S11 to repeat the processes of Step S11 and the subsequent steps. Meanwhile, if it is determined that the predetermined time (ten seconds) has elapsed, the operation proceeds to the next Step S19.

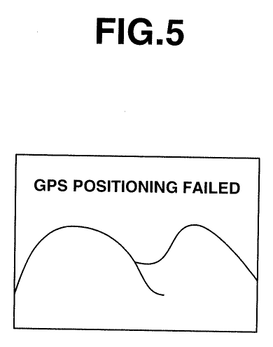

At the Step S19, the first CPU 31 controls the TFT liquid crystal drive circuit 9 to perform a positioning error display process of displaying on the TFT panel 10 an error display indicating the failure of the positioning, e.g., a display screen as illustrated in FIG. 5. Thereafter, the sequence of processes is completed (RETURN).

Meanwhile, if the GPS control function unit 31b determines in the process of the Step S13 that the necessary number of satellite signals have been successfully acquired within the predetermined time (ten seconds), the operation proceeds to the process of the Step S14. Then, at the Step S14, the GPS control function unit 31b performs a process of receiving the signals outputted from the signal tracking unit 36b to receive navigation data from the acquired wireless signals from the respective positioning satellites.

Subsequently, at Step S15, the GPS control function unit 31b confirms whether or not the navigation data has been successfully received. Herein, if it is determined that the navigation data has failed to be received, the operation proceeds to the process of the Step S19. At the Step S19, the above-described positioning error display process is performed. Thereafter, the sequence of processes is completed (RETURN).

Meanwhile, if the GPS control function unit 31b determines in the process of the Step S15 that the navigation data has been successfully received, the GPS control function unit 31b proceeds to the process of the next Step S16.

At the Step S16, on the basis of the received navigation data and so forth, the GPS control function unit 31b controls the navigation message combining and pseudorange measuring unit 31ba and the positioning calculation unit 31bc to perform the process of calculating the positioning data. Thereafter, the operation proceeds to the process of Step S17.

At the Step S17, the GPS control function unit 31b transmits the positioning data, which is the result of the calculation performed in the process of the Step S16, to the file management function unit 31c. Thereby, the positioning data is temporarily held in an internal memory (not illustrated) of the file management function unit 31c. Thereafter, the sequence of processes is completed, and the operation returns to the foregoing FIG. 3 (RETURN) to proceed to the process of the Step S5 of the drawing.

Subsequently, referring back to FIG. 3, the first CPU 31 confirms whether or not a shooting instruction has been issued at the Step S5 of the drawing. In the above process, the determination of whether or not the shooting instruction has been issued is made as the first CPU 31 confirms the presence or absence of a shooting instruction signal generated by the release button of the operation members included in the key matrix 23, for example. Herein, if the shooting instruction signal is confirmed by the first CPU 31 and thus the issuance of the shooting instruction is determined, the operation proceeds to the process of the next Step S6. Meanwhile, if it is determined that the shooting instruction has not been issued, the operation proceeds to the process of Step S9.

At the Step S6, the first CPU 31 performs a predetermined shooting operation process. In the shooting operation process performed herein, a similar operation to the shooting operation process performed by a normal and common digital camera is performed.

Simply described, the shooting operation process is performed under the control of the first CPU 31. That is, the first CPU 31 first receives a first release signal, and performs an automatic exposure (AE) operation, an automatic focusing (AF) operation, and so forth. Thereafter, the first CPU 31 receives a second release signal, and performs the photoelectric conversion process with the image pickup device 2, the analog signal processing with the image pickup circuit 3, the signal conversion process with the A/D converter 4, the digital signal processing with the signal processing circuit 5, and so forth.

After the completion of the process of the shooting operation at the Step S6, the operation proceeds to the process of Step S7.

Then, at the Step S7, the first CPU 31 confirms whether or not the positioning data generated by the GPS control function unit 31b is temporarily stored in, for example, the internal memory (not illustrated) or the like of the file management function unit 31c of the first CPU 31. Herein, if the presence of the positioning data is confirmed, the operation proceeds to the process of the next Step S8. Meanwhile, if the absence of the positioning data is confirmed, the operation proceeds to the process of the Step S9.

Subsequently, at the Step S8, the first CPU 31 transmits the positioning data temporarily stored in the internal memory thereof to the second CPU 32. Then, in the second CPU 32, a process of adding the positioning data to the shooting data generated in association with the predetermined image data is performed. The shooting data is then combined with the image data obtained by the shooting operation to generate a single image file. The image file is subjected to the image compression process by the image compression and expansion unit 32a to generate the compressed image file.

In accordance with the control by the recording medium access unit 32b, the compressed image file is transmitted to the recording medium 16 via the record buffer 14 and the recording medium I/F 15, and is recorded in a predetermined area of the recording medium 16 in a predetermined format.

After the process of the Step S8 is thus completed, the operation proceeds to the process of the Step S9.

The process of the Step S9 is performed when it is determined in the process of the Step S5 that the shooting instruction has not been issued, when it is determined in the process of the Step S7 that there is no positioning data obtained by the GPS, or when the process of generating the image file containing the positioning data is completed in the process of the Step S8.

At the Step S9, the first CPU 31 confirms whether or not the set scene mode has been changed to another mode. Herein, if the change to another scene mode is confirmed, the operation returns to the process of the Step S2 to repeat the processes of the Step S2 and the subsequent steps. Meanwhile, if it is determined that the scene mode has not been changed, the operation proceeds to the process of the next Step S10.

At the Step S10, the first CPU 31 confirms whether or not the operation mode of the digital camera has been changed from the shooting mode to a replay mode, or whether or not the power supply has been turned off. Herein, if it is determined that the operation mode has not been changed to the replay mode and that the power supply remains in the ON state, the operation returns to the process of the Step S3 to repeat the processes of the Step S3 and the subsequent steps. Meanwhile, if it is determined that the operation mode has been changed to the replay mode or that the power supply has been switched to the OFF state, the sequence of processes is completed.

As described above, according to the first embodiment, if the shooting mode set prior to the shooting operation in accordance with the selection and instruction by the user is the scene mode, whether or not the set scene mode is suitable for the positioning operation by the GPS is confirmed. Then, if the set scene mode is determined to be suitable for the positioning operation by the GPS, the execution of the positioning operation process is permitted on the assumption that the digital camera is under the obstacle-free condition, such as the open air, and thus is in the environment suitable for the positioning operation by the GPS. Meanwhile, if the set scene mode is determined to be unsuitable for the positioning operation by the GPS, the positioning operation process is not executed to omit the operation process on the assumption that the digital camera is in the environment unsuitable for the positioning operation by the GPS, such as the indoor or underwater environment. Further, in the above case, the control means (the first CPU 31) controls the battery 26 and so forth via the power supply circuit 27 to limit the electric power supply to the positioning means.

According to the present embodiment, therefore, the setting state of the scene mode set prior to the shooting operation is confirmed, and the suitability or unsuitability of the positioning operation is determined on the basis of the result of the confirmation. Then, if the digital camera is under the condition unsuitable for the positioning operation, unnecessary execution of the positioning operation is inhibited (omitted). Therefore, the waste of electric power is suppressed. As a result, the embodiment contributes to power saving.

Subsequently, a digital camera according to a second embodiment of the present invention will be described below.

In the first embodiment described above, the positioning operation is not performed at all when the digital camera is in the environment unsuitable for the positioning operation.

However, even if the digital camera is set to the scene mode in which the digital camera is assumed to be in the environment unsuitable for the positioning operation, there is a possibility that the positioning data can be obtained by the positioning operation.

In the second embodiment of the present invention, therefore, in addition to the positioning operation of a normal pattern, which is the same as the positioning operation performed in the first embodiment (see FIG. 4), a positioning operation of a pattern in consideration of the power saving is prepared. Thus, if the digital camera is set to the scene mode unsuitable for the positioning operation, the positioning operation of the latter type (the positioning operation of the pattern in consideration of the power saving) is performed. Accordingly, the embodiment can increase the possibility of acquiring the positioning data while in consideration of the power saving.

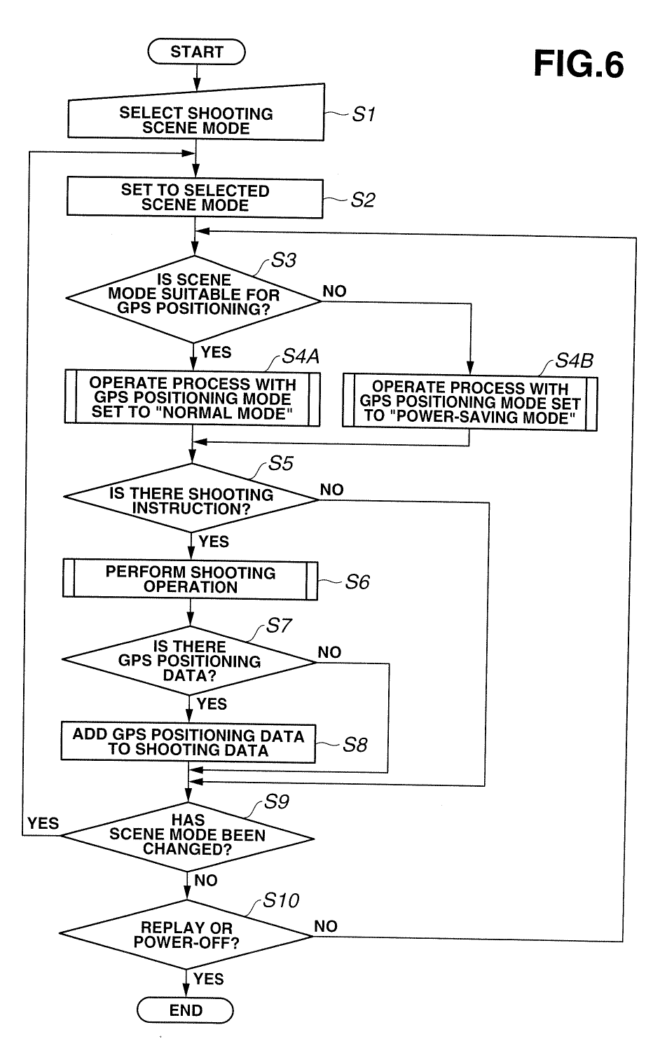

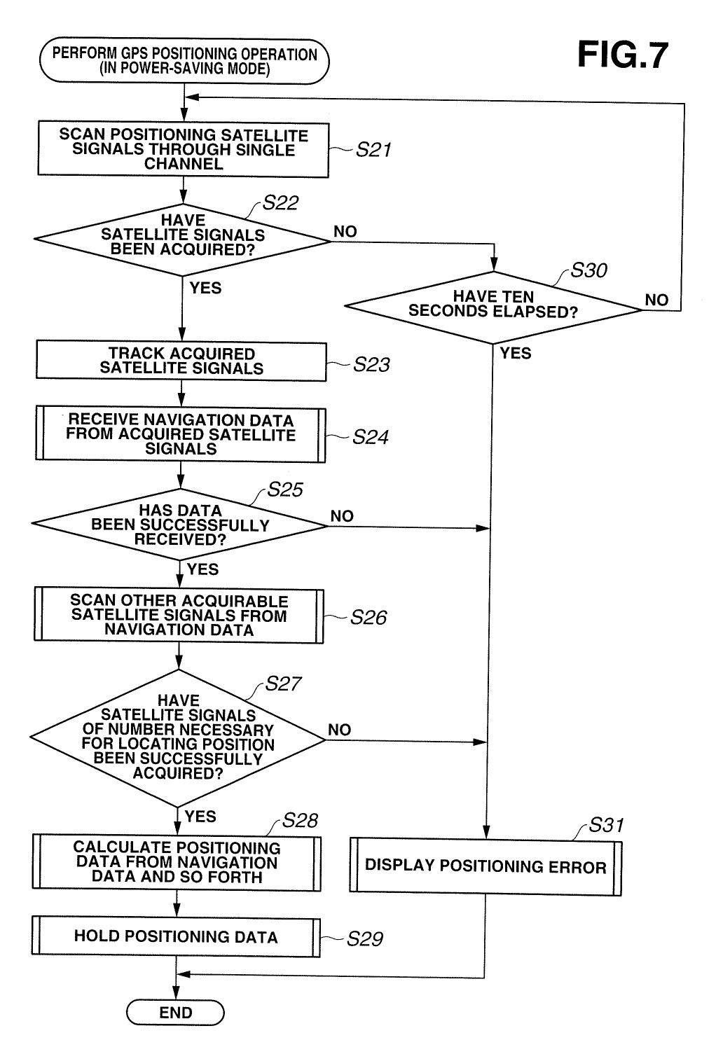

FIGS. 6 and 7 are flowcharts illustrating an operation performed in the shooting operation by the digital camera according to the second embodiment of the present invention. FIG. 6 is a processing sequence illustrating the flow of the shooting operation involving the GPS positioning operation. FIG. 7 is a processing sequence illustrating details of an operation constituting the processing sequence of FIG. 6, which is performed when the positioning operation process is performed in a power-saving mode.

The main configuration of the digital camera according to the present embodiment is exactly the same as the main configuration of the digital camera according to the foregoing first embodiment. The present embodiment is different from the first embodiment only in the control of the positioning operation using the GPS controlled and performed by the GPS control function unit 31b. Therefore, the following description will be made with reference to FIGS. 1 and 2, with detailed description of the configuration of the digital camera omitted.

With reference to FIGS. 6 and 7 (and FIG. 4), description will be made below of the operation performed in the shooting operation by the digital camera according to the present embodiment.

A user first performs a selection operation of selecting a desired operation mode on the assumption that the power supply of the digital camera according to the present embodiment is in the ON state, and that the digital camera is in a state in which the shooting operation can be performed, i.e., the digital camera is set to the shooting mode.

In the above-described state, the digital camera according to the present embodiment starts the processing sequence of FIG. 6. The processing sequence illustrated in FIG. 6 is substantially similar to the processing sequence of the foregoing first embodiment illustrated in FIG. 3. Therefore, the same process steps will be assigned with the same step numbers, and detailed description of the process steps will be omitted.

As illustrated in FIG. 6, in the process of the Step S3 of the present embodiment, the scene mode control function unit 31d confirms whether or not the set scene mode is suitable for the positioning operation by the GPS. Then, if the set scene mode is determined to be suitable for the GPS positioning operation, the operation proceeds to the next Step S4A.

Then, at the Step 4A, the scene mode control function unit 31d causes the positioning operation process to operate in a normal mode.

In the above case, as the process of the Step S4A, i.e., the process for causing the positioning operation process to operate in the normal mode, a processing sequence exactly similar to the processing sequence of the positioning operation process of the foregoing first embodiment (see FIG. 4) is applied.

Meanwhile, if it is determined in the previously described process of the Step S3 that the set scene mode is unsuitable for the GPS positioning operation, the process of the Step S4 is omitted and the operation proceeds to the process of the Step S5 in the foregoing first embodiment (FIG. 3). That is, the positioning operation is not performed in the foregoing first embodiment.

In contrast, in the present embodiment (FIG. 6), if it is determined in the process of the Step S3 that the set scene mode is unsuitable for the GPS positioning operation, the operation proceeds to the process of Step S4B. Then, at the Step S4B, the scene mode control function unit 31d causes the positioning operation process to operate in the power-saving mode.

The processing sequence of the operation performed in the positioning operation process in the power-saving mode is as illustrated in FIG. 7.

The present embodiment is similar to the foregoing first embodiment in that the GPS positioning operation process (in the power-saving mode) illustrated in FIG. 7 is performed under the control of the GPS control function unit 31b of the system control unit 31a of the first CPU 31.

At Step S21, the GPS control function unit 31b first controls the GPS signal processing function unit 37 and the signal acquisition unit 36a of the GPS signal calculation function unit 36 to perform the GPS signal acquisition operation process in a single channel to scan the wireless signals from the positioning satellites. At the time of starting the GPS positioning operation process (in the power-saving mode), the first CPU 31 starts the timekeeping operation by using the RTC internal clock (not illustrated) thereof.

In other words, the GPS control function unit 31b controls the positioning means so as to stop the operation of a part of the positioning means and limit the number of the positioning satellites simultaneously acquired by the signal acquisition unit 36a (the satellite acquisition means).

That is, in the GPS positioning operation process in the power-saving mode, the GPS control function unit 31b drives and controls only a single channel to perform the GPS signal acquisition operation process. Namely, in the positioning operation process in the power-saving mode, the GPS control function unit 31b of the first CPU 31 constituting the control means performs a control to stop a part of the operation of the positioning means, and only drives a single channel of the signal acquisition unit 36a of the GPS signal calculation function unit 36. In the above process, the first CPU 31 constituting the control means controls the battery 26 and so forth via the power supply circuit 27 to limit the electric power supplied to the positioning means. Accordingly, the electric power supply to the constituent components constituting the positioning means (e.g., the GPS signal calculation function unit 36) can be reduced, as compared with the positioning operation in the normal mode.

Then, at Step S22, the GPS control function unit 31b confirms whether or not the signal acquisition unit 36a has acquired the wireless signals (the GPS signals) from the positioning satellites. Herein, if the acquisition of the GPS signals is confirmed, the operation proceeds to the process of the next Step S23. Meanwhile, if the acquisition of the GPS signals is not confirmed, the operation proceeds to the process of Step S30.

At the Step S30, the GPS control function unit 31b refers to the RTC internal clock (not illustrated) of the first CPU 31, and confirms whether or not a predetermined time (ten seconds in the present embodiment, for example) has elapsed since the starting time of the process of the Step S21. Herein, if the predetermined time (ten seconds) has not elapsed, the operation returns to the process of the Step S21 to repeat the processes of the Step S21 and the subsequent steps. Meanwhile, if it is determined that the predetermined time (ten seconds) has elapsed, the operation proceeds to the process of the next Step S31.

At the Step S31, the first CPU 31 controls the TFT liquid crystal drive circuit 9 to perform the positioning error display process of displaying on the TFT panel 10 the error display indicating the failure of the positioning (e.g., the display screen illustrated in FIG. 5). Thereafter, the sequence of processes is completed (END).

Meanwhile, if it is determined in the process of the Step S22 that the GPS signals have been acquired, the operation proceeds to the process of the next Step S23. Then, at the Step S23, the GPS control function unit 31b controls the signal tracking unit 36b of the GPS signal calculation function unit 36 to perform a process of tracking the wireless signals from the positioning satellites acquired by the signal acquisition unit 36a (a signal channel) in the process of the Step S22 and continuing to receive the wireless signals from the positioning satellites. Thereafter, the operation proceeds to the process of the next Step S24.

At the Step S24, the GPS control function unit 31b receives signals outputted from the signal tracking unit 36b, and performs a process of receiving navigation data from the acquired wireless signals from the positioning satellites.

Then, at Step S25, the GPS control function unit 31b confirms whether or not the navigation data has been successfully received. Herein, if it is determined that the navigation data has failed to be received, the operation proceeds to the process of the Step S31. Then, at the Step S31, the above-described positioning error display process is performed. Thereafter, the sequence of processes is completed (END).

If the GPS control function unit 31b determines in the process of the Step S25 that the navigation data has been successfully received, the GPS control function unit 31b proceeds to the process of the next Step S26.

At the Step S26, the GPS control function unit 31b controls the GPS signal processing function unit 37 and the signal acquisition unit 36a of the GPS signal calculation function unit 36 to perform the GPS signal acquisition operation process in other plurality of channels. In the above process, on the basis of the navigation data received in the process of the Step S24, the GPS control function unit 31b scans other acquirable wireless signals from the positioning satellites.

Subsequently, at Step S27, the GPS control function unit 31b confirms whether or not satellite signals of a number necessary for the positioning (the locating of the position) have been successfully acquired. Herein, if the GPS control function unit 31b determines that the necessary number of satellite signals have been successfully acquired, the GPS control function unit 31b proceeds to the process of the next Step S28. Meanwhile, if it is determined that the necessary number of satellite signals have failed to be received, the operation proceeds to the process of the Step S31. At the Step S31, the above-described positioning error display process is preformed. Thereafter, the sequence of processes is completed (END).

If the GPS control function unit 31b determines in the process of the Step S27 that the necessary number of satellite signals have been successfully acquired, the operation proceeds to the process of the next Step S28. Then, at the Step S28, on the basis of the received navigation data and so forth, the GPS control function unit 31b controls the navigation message combining and pseudorange measuring unit 31ba and the positioning calculation unit 31bc to perform a process of calculating the positioning data. Thereafter, the operation proceeds to the process of Step S29.

At the Step S29, the GPS control function unit 31b transmits the positioning data, which is the result of the calculation performed in the process of the Step S28, to the file management function unit 31c. Thereby, the positioning data is temporarily stored in the internal memory (not illustrated) of the file management function unit 31c. Thereafter, the sequence of processes is completed, and the operation returns to the foregoing FIG. 6 to proceed to the process of the Step S5 of the drawing.

As described above, according to the second embodiment, similarly as in the foregoing first embodiment, if the shooting mode set prior to the shooting operation in accordance with the selection and instruction by the user is the scene mode, whether or not the set scene mode is suitable for the positioning operation by the GPS is confirmed. Then, if the set scene mode is determined to be suitable for the positioning operation by the GPS, the positioning operation process in the normal mode (see FIG. 4) is performed on the assumption that the digital camera is under the obstacle-free condition, such as the open air, and thus is in the environment suitable for the positioning operation by the GPS.

Meanwhile, if the set scene mode is determined to be unsuitable for the positioning operation by the GPS, the digital camera is assumed to be in the environment unsuitable for performing the positioning operation by the GPS, such as the indoor or underwater environment.

In the above case, the execution of the positioning operation process is not inhibited (omitted) and the positioning operation process in the power-saving mode (see FIG. 7) is performed in the present embodiment, unlike in the foregoing first embodiment. Further, if the positioning cannot be performed even with the positioning operation in the power-saving mode, the positioning error display is displayed.

According to the present embodiment, therefore, the setting state of the scene mode set prior to the shooting operation is confirmed, and the suitability or unsuitability of the positioning operation is determined on the basis of the result of the confirmation. Then, if the digital camera is under the condition unsuitable for the positioning operation, the positioning operation in the power-saving mode is performed. Accordingly, the present embodiment can increase the possibility of acquiring the positioning data while suppressing the waste of electric power.

In the respective embodiments described above, the type of the set scene mode is confirmed as a determination criterion for determining whether the circumstance in which the digital camera is in is suitable or unsuitable for the positioning operation. Needless to say, however, the determination criterion for determining the suitability or unsuitability of the positioning operation is not limited to the above, and thus the determination may be based on another determination criterion.

For example, as another means for determining the suitability or unsuitability of the positioning operation, means for referring to the setting mode of the white balance (WB), for example, is conceivable.

Specifically, the white balance setting mode suitable for the positioning operation by the GPS includes, for example, a fine weather WB mode, a cloudy weather WB mode, and so forth, while the white balance setting mode unsuitable for the positioning operation by the GPS includes, for example, a fluorescent light WB mode, an incandescent light WB mode, and so forth,

A normal digital camera has a function of automatically setting the white balance on the basis of the image signal obtained by the image pickup device 2. Further, the white balance setting can be arbitrarily selected and set by a user.

It is easily possible to determine the availability or unavailability of the positioning operation or to switch the positioning mode by referring to the state of the white balance setting automatically or manually set in the above-described manner.

Further, in addition to the control (of the scene mode) by the respective embodiments described above, the set condition of the white balance may be additionally taken into account to determine the availability or unavailability of the positioning operation or to switch the positioning mode.

In the respective embodiments described above, the description has been made of the example of the photographic device, such as the digital camera, including the positioning means using the GPS. The present invention, however, is not limited to the above example, and thus can be applied to, for example, an electronic device which has a shooting and recording function capable of obtaining digital image data through the shooting operation and recording the obtained image data, and which includes the positioning means using the GPS, for example, an electronic notebook and a small-sized information device including a mobile phone and a mobile computer, for example.

It is obvious in the present invention that different embodiments can be configured in a wide range on the basis of the invention without departing from the spirit and scope of the invention. The present invention is not limited by a particular embodiment thereof, except being limited by the appended claims.

What is claimed is:

1. A digital camera comprising:
a shooting unit for shooting a subject and generating an image signal;
a recording unit for recording on a recording medium image data based on the image signal obtained by the shooting unit;
a shooting mode selection unit for selecting and setting a shooting mode for setting a shooting condition under which the subject is shot by the shooting unit;
a positioning unit for locating thereof by receiving a plurality of signals transmitted from a plurality of signal sources;
a power supply for supplying electric power to at least the shooting unit, the recording unit, and the positioning unit; and
a control unit for controlling the operation of the positioning unit in accordance with the shooting mode selected and set by the shooting mode selection unit, and for controlling the electric power supplied from the power supply to the positioning unit.

2. The digital camera according to claim 1,
wherein the positioning unit locates the position thereof on the earth by receiving a signal from a positioning satellite.

3. The digital camera according to claim 2,
wherein, when the shooting mode selected and set by the shooting mode selection unit is a shooting mode for shooting the subject in an indoor or underwater environment, the control unit performs a control to stop a part or the whole of the operation of the positioning unit, and a control of the power supply to stop or limit the electric power supplied to the positioning unit.

4. The digital camera according to claim 3,
wherein the positioning unit includes a satellite acquisition unit capable of simultaneously acquiring a plurality of positioning satellites, and
wherein, when the shooting mode selected and set by the shooting mode selection unit is the shooting mode for shooting the subject in the indoor or underwater environment, the control unit performs a control of the positioning unit to stop the operation of a part of the positioning unit and limit the number of the positioning satellites simultaneously acquired by the satellite acquisition unit, and a control of the power supply to limit the electric power supplied to the positioning unit.

5. The digital camera according to claim 1,
wherein the shooting mode selected and set by the shooting mode selection unit is a scene mode.
